(19) United States
(12) Patent Application Publication
(10) Pub. No.: US 2025/0389884 A1
(43) Pub. Date: Dec. 25, 2025

(54) DISPLAY APPARATUS, OPTICAL APPARATUS, AND IMAGE PICKUP APPARATUS

(71) Applicant: CANON KABUSHIKI KAISHA, Tokyo (JP)

(72) Inventor: Yui MIZUTANI, Saitama (JP)

(21) Appl. No.: 19/232,940

(22) Filed: Jun. 10, 2025

(30) Foreign Application Priority Data
Jun. 25, 2024 (JP) 2024-102328

(51) Int. Cl. G02B 5/30

(52) U.S. Cl. CPC G02B 5/3058

(57) ABSTRACT

A display apparatus includes an optical system including a transmissive reflective element, and a display element. The transmissive reflective element includes a substrate having a curved surface, convex portions disposed on the curved surface along a first direction, and a conductor provided on each convex portion. Each convex portion extends in a second direction orthogonal to the first direction and protrudes in a third direction orthogonal to each of the first and second directions. Each convex portion has an end surface in the third direction and first and second side surfaces on both sides of the end surface in the first direction. In a section including the first direction and the third direction, the conductor covers at least a part of the end surface and at least a part of the first side surface of each of the plurality of convex portions. A predetermined inequality is satisfied.

### BACKGROUND

### Technical Field

The present disclosure relates to a display apparatus, an optical apparatus, and an image pickup apparatus.

### Description of Related Art

Japanese Patent Application Laid-Open No. 2021-81530 discloses an observation optical system (virtual reality (VR) optical system) using two half-transmissive surfaces. Japanese Patent Application Laid-Open No. 2021-81530 uses a film-shaped wire grid polarizer as a polarization-selective transmissive reflective element for one of the two half-transmissive surfaces. Japanese Patent Application Laid-Open No. 2010-39183 discloses a method for manufacturing a film-shaped wire grid polarizer by forming a grating-shaped uneven structure while winding a rolled substrate film, and by depositing a metal while changing a deposition angle in oblique deposition.

### SUMMARY

A display apparatus according to one aspect of the present disclosure includes an optical system including a transmissive reflective element, and a display element. The transmissive reflective element includes a substrate having a curved surface, a plurality of convex portions disposed on the curved surface along a first direction, and a conductor provided on each of the plurality of convex portions. Each of the plurality of convex portions extends in a second direction orthogonal to the first direction and protrudes in a third direction orthogonal to each of the first direction and the second direction. Each of the plurality of convex portions has an end surface in the third direction and a first side surface and a second side surface disposed on both sides of the end surface in the first direction. In a section including the first direction and the third direction, the conductor covers at least a part of the end surface and at least a part of the first side surface of each of the plurality of convex portions. The following inequality is satisfied:

$$\vert α1 \vert \leq 45$$

where α1 (°) is an angle in a used state between the second direction and a direction in which user's eyes are aligned.

An optical apparatus according to another aspect of the disclosure includes a first optical system and a second optical system arranged in parallel. Each of the first optical system and the second optical system includes a transmissive reflective element. The transmissive reflective element includes a substrate having a curved surface, a plurality of convex portions disposed on the curved surface along a first direction, and a conductor provided on each of the plurality of convex portions. Each of the plurality of convex portions extends in a second direction orthogonal to the first direction and protrudes in a third direction orthogonal to each of the first direction and the second direction. Each of the plurality of convex portions has an end surface in the third direction and a first side surface and a second side surface disposed on both sides of the end surface in the first direction. In a section including the first direction and the third direction, the conductor covers at least a part of the end surface and at least a part of the first side surface of each of the plurality of convex portions. The following inequality is satisfied:

$$\vert α2 \vert \leq 45$$

where α2 (°) is an angle between the second direction and an arrangement direction of the first optical system and the second optical system.

An image pickup apparatus according to another aspect of the disclosure includes an optical system including a transmissive reflective element, and an image sensor. The transmissive reflective element includes a substrate having a curved surface, a plurality of convex portions disposed on the curved surface along a first direction, and a conductor provided on each of the plurality of convex portions. Each of the plurality of convex portions extends in a second direction orthogonal to the first direction and protrudes in a third direction orthogonal to each of the first direction and the second direction. Each of the plurality of convex portions has an end surface in the third direction and a first side surface and a second side surface disposed on both sides of the end surface in the first direction. In a section including the first direction and the third direction, the conductor covers at least a part of the end surface and at least a part of the first side surface of each of the plurality of convex portions. The following inequality is satisfied:

$$\vert α3 \vert < 90 - {tan}^{- 1} ( b / a )$$

where a is a length in a long side direction of the image sensor, b is a length in a short side direction of the image sensor, and α3 (°) is an angle between the second direction and the long side direction.

Further features of various embodiments of the disclosure will become apparent from the following description of embodiments with reference to the attached drawings.

### BRIEF DESCRIPTION OF THE DRAWINGS

FIG. 1 is a front view of a transmissive reflective element according to each example.

FIG. 2 is a partially enlarged sectional view of the transmissive reflective element according to each example.

FIG. 3 explains a shape of a conductor according to each example.

FIG. 4 is a sectional view of a display apparatus according to Example 1.

FIG. 5 is an external view of the display apparatus according to Example 1.

FIG. 6 is a side view of a transmissive reflective element according to Example 1.

FIGS. 7A, 7B, and 7C illustrate the transmittance and reflectance in Example

1.

FIG. 8 illustrates color unevenness of transmission light of the transmissive reflective element according to Example 1.

FIG. 9 is a sectional view of an observation optical system according to Example 1.

FIG. 10 illustrates the color unevenness of transmission light of the transmissive reflective element according to comparative example 1.

FIG. 11 is a sectional view of an image pickup apparatus according to Example 2.

FIG. 12 is a side view of a transmissive reflective element according to Example 2.

FIGS. 13A and 13B illustrate the transmittance and reflectance in Example

2.

FIG. 14 illustrates color unevenness of transmission light through a transmissive reflective element according to Example 2.

FIG. 15 is a sectional view of an image pickup apparatus according to Example 3.

FIG. 16 is a side view of a transmissive reflective element according to Example 3.

FIGS. 17A and 17B illustrate the transmittance and reflectance in Example 3.

### DETAILED DESCRIPTION

Referring now to the accompanying drawings, a detailed description will be given of examples according to the disclosure.

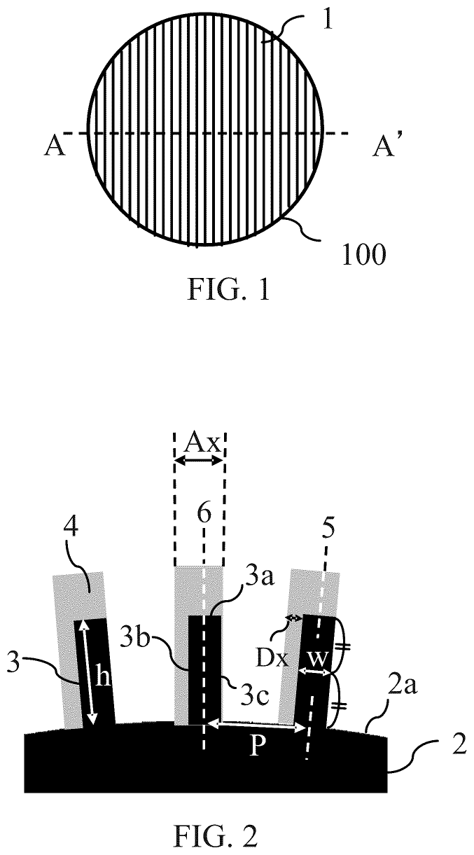

Referring now to FIGS. 1 and 2, a description will be given of a transmissive reflective element (polarization-selective transmissive reflective element, optical element) 100 according to each example. FIG. 1 is a front view of the transmissive reflective element 100. In FIG. 1, a horizontal direction is a first direction (arrangement direction of a plurality of convex portions 3), and a vertical direction is a second direction (extending direction of the convex portion 3). FIG. 2 is a sectional view of a partially enlarged portion of the transmissive reflective element 100, illustrating a schematic enlarged part of a sectional shape of the transmissive reflective element 100 cut along line A-A′ in FIG. 1. In FIG. 2, a direction along the curved surface 2a of the substrate 2 (arrangement direction of the plurality of convex portions 3) is the first direction, and a paper depth direction is the second direction (extending direction of the convex portion 3). A direction orthogonal to each of the first and second directions is a third direction (surface normal direction 5), which corresponds to a direction in which the convex portions 3 protrude from the substrate 2. The third direction of a specific convex portion 3 (e.g., the convex portion 3 located at the center (portion) of the transmissive reflective element 100) among the plurality of convex portions 3 is a direction along an optical axis 6.

As illustrated in FIG. 2, an uneven (concave-convex) structure consisting of a plurality of convex portions 3 and the concave portions formed between two adjacent convex portions 3 periodically extends in one direction (the second direction) (extends along one direction). Extending in one direction does not mean that the uneven structure is to extend strictly parallel, but is to extend approximately parallel. FIGS. 1 and 2 are deformed drawings that are different from the actual scale.

As illustrated in FIG. 1, a plurality of thin conductor wires 1 extending in the vertical direction are formed on one surface of the transmissive reflective element 100. As illustrated in FIG. 2, the transmissive reflective element 100 includes the substrate (substrate) 2, convex portions 3 formed on the substrate 2 using the same material as the substrate 2, and conductors 4 formed on the tops (upper surfaces) and left side surfaces of the convex portions 3. However, each example is not limited to this implementation, and the conductor 4 may be formed on the upper surface and both side surfaces (both left side and right side) of the convex portion. That is, the conductor may be formed on at least one of the upper surface and both side surfaces of the convex portion. In each example, a plurality of convex portions 3 are disposed on the surface of the substrate 2 along the first direction (direction along the curved surface 2a of the substrate 2) at a predetermined pitch (arrangement pitch, pitch P). The conductor 4 in FIG. 2 corresponds to the thin conductor wire 1 in FIG. 1.

As illustrated in FIG. 2, each of the plurality of convex portions 3 protrudes in the third direction and has an upper surface 3a, a first side surface 3b, and a second side surface 3c opposite to the first side surface 3b. In other words, each of the plurality of convex portions 3 has an end surface (upper surface 3a) in the third direction, and a first side surface 3b and a second side surface 3c disposed on both sides of the end surface in the first direction.

The conductor 4 covers at least a part of the upper surface 3a of each of the plurality of convex portions 3 and at least a part of the first side surface 3b. The conductor 4 may cover at least a part of the second side surface 3c. Dx (nm) is a thickness of the conductor 4 in the first direction (direction along the curved surface 2a of the substrate 2) at the position of the top (upper surface 3a) of the convex portion 3. That is, Dx corresponds to the thickness of the conductor 4 provided on the first side surface 3b of the convex portion 3 at the position of the top of the convex portion 3 in the direction orthogonal to both the second direction and the surface normal direction 5 of the substrate 2.

The substrate 2 and the plurality of convex portions 3 are integrated, and integrally molded by injection molding using a thermoplastic resin and a lens mold having an uneven structure on its surface, for example. Alternatively, a grating may be formed on the lens surface by applying ultraviolet curing resin to the lens surface and pressing the mold against it.

The surface shape of the substrate 2 has a curved surface 2a. The convex portion 3 is formed so as to extend (protrude) in the surface normal direction 5 on the curved surface 2a of the substrate 2. For example, a lens mold in which the convex portion 3 extends in the surface normal direction 5 can be produced by patterning a concave-convex structure on the mirror frame surface of injection molding and then forming the concave-convex structure by etching. By integrally forming the substrate 2 and the convex portions 3, the process of bonding the transmissive reflective element to the optical element can be omitted, and disadvantages such as increased manufacturing costs and element defects caused by curved surfaces can be reduced.

The substrate 2 may be made of any material that is transparent in the target wavelength range, and examples of the material that can be used include methyl methacrylate resin (PMMA), polycarbonate resin (PC), cycloolefin resin (COP), cycloolefin copolymer (COC), polystyrene resin (PS), etc. In order to avoid a decrease in the polarization separation function, a phase change may be reduced in the light beam at the use wavelength, and a material with low birefringence properties may be used.

The thickness of the substrate 2 may be set to 100 μm or more so that the transmissive reflective element 100 can be easily held when incorporated in an optical system having a plurality of lenses.

The sectional shape of the convex portion 3 is a repetition of concave and convex shapes in the section (surface viewed from the second direction) illustrated in FIG. 2. This shape may be any shape, such as a rectangle, a parabola, a trapezoid, or a triangle, as long as the conductor 4 can be formed on at least one of the upper surface and both side surfaces of each of the plurality of convex portions 3. These sectional shapes are not strictly mathematically defined, and the convex portion 3 may have a blunted upper corner or a tapered bottom.

In each example, the conductor 4 is obliquely evaporated onto the convex portion 3 at a fixed angle to obtain the thin conductor wire 1. Thus, it is difficult to independently control the height of the conductor 4 deposited above the upper surface of the convex portion 3, and the height of the conductor 4 is highly dependent on the height of the convex portion 3. Since the wire grid polarizer exhibits good polarization separation performance in a case where the conductors 4 have a certain height or more, the height h (nm) of the convex portions 3 in the third direction may be similarly high. Thus, the height h of the convex portions 3 in the third direction may satisfy the following inequality (1):

$$50 \leq h \leq 300 \qquad ( 1 )$$

As the height h of the convex portion 3 increases, the area of the conductor 4 that adheres to the side surface of the convex portion 3 increases, improving adhesion. On the other hand, the extremely large height h causes manufacturing difficulty. Here, the height h of the convex portion 3 is a height in the surface normal direction 5 of the substrate 2 (the distance in the surface normal direction 5 from the curved surface 2a of the substrate 2 to the maximum height of the convex portion 3).

Inequality (1) may be replaced with inequality (1a) below:

$$55 \leq h \leq 300 \qquad ( 1 a )$$

Inequality (1) may be replaced with inequality (1b) below:

$$60 \leq h \leq 300 \qquad ( 1 b )$$

In a case where the conductor 4 is obtained by this method, the thickness Ax in the first direction of the conductor 4 in the region above the upper surface of the convex portion 3 depends on the width of the convex portion 3. Although the details will be described later, in order to obtain good polarization separation performance, it is necessary to control the thickness Ax in the first direction of the conductor 4 in the region above the upper surface of the convex portion 3. Thus, a width w (nm) in the first direction of the convex portion 3 at half the height h of the convex portion 3 may be reduced. Here, the thickness Ax in the first direction of the conductor 4 may be, for example, an average thickness in the first direction at the height of the top of the plurality of convex portions 3 in the transmissive reflective element 100. The width w of the convex portion 3 is the thickness in the first direction at the position of half the height h of the convex portion 3.

As described above, the height h of the convex portion 3 may be 50 nm or more, and properly setting a ratio h/w of the width w and height h of the convex portion 3 can achieve both moldability and good polarization separation performance. A fine convex portion with a width w of 10 nm or less is more likely to cause defects such as deformation or “peeling” during release in the injection molding process. Thus, the ratio h/w of the width w and height h of the convex portion 3 may satisfy the following inequality (2):

$$1.5 \leq h / w \leq 8. \qquad ( 2 )$$

Inequality (2) may be replaced with inequality (2a) below:

$$2. \leq h / w \leq 7.8 \qquad ( 2 a )$$

Inequality (2) may be replaced with inequality (2b) below:

$$3.5 \leq h / w \leq 7.5 \qquad ( 2 b )$$

In each example, the pitch P (nm) of the plurality of convex portions 3 may satisfy the following inequality (3):

$$70 \leq P \leq 170 \qquad ( 3 )$$

In general, as the pitch P of the conductor 4 is reduced, the polarization separation performance of the wire grid polarizer over a wide wavelength range is improved. In a case where the pitch P is large relative to the target wavelength, unnecessary light is generated due to diffraction, and the polarization separation performance deteriorates. Thus, in order to achieve high polarization separation performance in the visible range, the pitch P may be 170 nm or less.

In order to form a fine uneven structure, the pitch P may be 70 nm or more. In a case where the pitch P is 70 nm or less, it is necessary to make the width w of the convex portion 3 in the first direction smaller than 10 nm for a good relationship between the thickness Ax in the first direction of the conductor in the region above the upper surface of the convex portion 3 described later and the pitch P. The pitch P does not need to be such that the plurality of convex portions 3 are disposed at strictly equal intervals, and it is acceptable for there to be a variation of about 10% within the surface due to manufacturing errors and shrinkage caused during transfer of the convex portions 3. The pitch P is a distance between the centers of the convex portions 3 in the surface normal direction 5 at the root portions of the convex portions 3 (a distance between a first intersection between the centerline in the surface normal direction of a first convex portion and the curved surface 2a of the substrate 2 and a second intersection between the center line in the surface normal direction 5 of a second convex portion adjacent to the first convex portion and the curved surface 2a).

Inequality (3) may be replaced with inequality (3a) below:

$$75 \leq P \leq 165 \qquad ( 3 a )$$

Inequality (3) may be replaced with inequality (3b) below:

$$80 \leq P \leq 160 \qquad ( 3 b )$$

The conductor 4 may be made of a material with high reflectivity in the visible light range, such as aluminum, silver, gold, chromium, zirconium, titanium, copper, tungsten, magnesium, tantalum, platinum, or an alloy containing these as main components.

At least a part of the upper surface and at least a part of one side surface (and at least a part of the concave portion) of the convex portions 3 of the uneven structure is covered with the conductor 4 to form the thin conductor wire 1. The method of covering the convex portions 3 with the conductor 4 is not limited as long as it is the conductor 4 can be applied to the convex portions 3, such as a vacuum deposition method or a sputtering method. For example, by using the oblique deposition method in the vacuum deposition method, the deposition angle θ can be properly set according to the shape or pitch P of the convex portions 3, and the shape of the conductor 4 can be easily controlled. Here, the deposition angle θ is an angle between a direction along the optical axis 6 and a deposition direction from a deposition source.

The oblique deposition may use a fixed angle for a good polarization separation function while keeping manufacturing costs low. In a case where oblique deposition is performed for the convex portions 3, the adjacent convex portions 3 serve as shields, and form areas where the deposition material is not deposited, and the conductor 4 can be formed on one side of the convex portions 3. Depending on the incident angle of the deposition material on the convex portions 3, the conductor may also be deposited on the concave portions, and one side of the convex portion may have an undeposited area.

In a case where the substrate (base) is a flat plate, the conductor formed by oblique deposition from a fixed angle is generally uniform within the surface of the optical element, although there may be some variation due to manufacturing errors. However, in an optical element (curved element) with a curved substrate, in a case where the conductor 4 is deposited by oblique deposition from a fixed angle toward the convex portion 3 extending in the surface normal direction 5, the film thickness and shape of the conductor 4 are not uniform in the section of FIG. 2. As a result, four roughly divided patterns of conductor shapes are obtained.

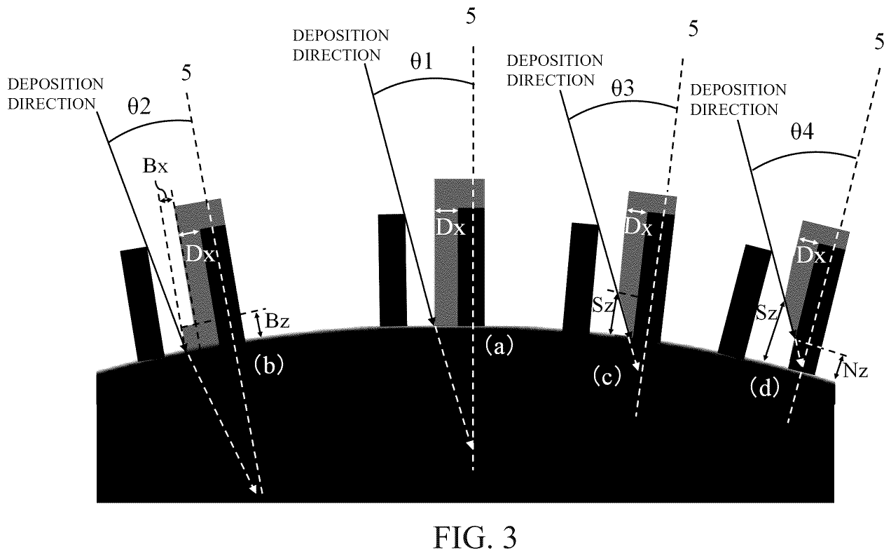

FIG. 3 explains four conductor-shape patterns (a) to (d). Pattern (a) in which the conductor extends upward from the bottom of the concave portion to cover the top surface of the convex portion provides a conductor shape with the highest polarization separation performance. Here, Dx (nm) is a thickness in the first direction of the conductor deposited on the side surface of the convex portion at the top of the convex portion. The conductor on the side surface of the convex portion is deposited with a substantially uniform thickness from the concave portion to the top of the convex portion. An incident angle of the deposition material onto the convex portion having such a conductor shape is θ1. Here, the incident angle of the deposition material onto the convex portion is an angle between the surface normal direction 5 at the center of the width of the convex portion and the deposition direction from the deposition source. In pattern (a), the surface normal direction 5 coincides with the optical axis direction, so the deposition angle θ and the incident angle θ1 coincide.

In a case where the substrate is a flat plate and the deposition material is obliquely deposited at an incident angle θ1 to the convex portions to form such a conductor shape, a conductor shape as illustrated in pattern (a) in FIG. 3 is formed over the entire surface of the optical element.

On the other hand, in a case where the substrate is a curved surface, an incident angle of the deposition material to the convex portions is smaller than θ1 (incident angle θ2) in a region closer to the deposition source than a position where pattern (a) that provides the conductor shape with the highest polarization characteristic (optical characteristic). At this time, for example, a conductor shape like pattern (b) in FIG. 3 is obtained. The conductor shape of pattern (b) has a shape in which the conductor is deposited in the concave portion with a thickness greater than Dx. The curvature of the substrate in FIG. 3 is positive, but in a case where the curvature is negative and the incident angle of the deposition material is greater than θ1, the conductor shape of FIG. 3(b) is formed. In FIG. 3, since the curvature of the substrate is positive, in a case where the central region of the optical element is obliquely deposited at an incident angle θ1 of the deposition material that forms an ideal conductor shape as in FIG. 3(a), the region to the left of the center of the optical element forms the conductor shape of FIG. 3(b). The incident angle of the deposition material onto the convex portion at that time is θ2 (θ2<θ1). Pattern (b) provides a conductor shape with a value Bx (nm) greater than 0, which is obtained by subtracting the thickness Dx from the maximum thickness of the conductor deposited on the side surface of the convex portion 3 in the first direction. Bz is a film thickness in the surface normal direction 5 of the conductor deposited in the concave portion thicker than the thickness Dx.

As the value Bx increases, the incident angle θ2 of the deposition material moves away from the incident angle θ1, the conductor shape also moves away from the ideal conductor shape, and the polarization characteristic deteriorates.

On the other hand, in a region farther from the deposition source than the position of the optical element forming the ideal conductor shape, pattern (a), the incident angle of the deposition material onto the convex portions becomes larger than θ1, a conductor shape becomes as in patterns (c) and (d). Here, the curvature of the substrate in FIG. 3 is positive, but in a case where the curvature is negative and the incident angle of the deposition material is smaller than θ1, the conductor shapes of patterns (c) and (d) are formed. The incident angles of the deposition material to the convex portion at this time are θ3 and θ4. This region is located on the right side of the center of the optical element in FIG. 3. The conductor shape of pattern (c) has a height Sz (nm) in the third direction of the region where the conductor attached to the side surface of the convex portion near the substrate decreases (is tapered). The conductor shape of pattern (d) is formed in a region where the incident angle of the deposition material is greater than the incident angle 03, and has an area of height Sz and a region of height Nz (completely undeposited area). The completely undeposited region where no film is formed on the side of the convex portion has the height Nz (nm) in the third direction.

As the region of the height Sz is reduced and the completely undeposited region of the height Nz expands, the incident angles θ3 and θ4 are separated from the incident angle θ1, the conductor shape moves away from the ideal conductor shape, and the polarization separation performance deteriorates.

In the conductor shape of pattern (a) in FIG. 3, all of Bx, Sz, and Nz are 0. In summary, in a case where oblique deposition is performed at a fixed angle onto the convex portions extending in the surface normal direction of the curved substrate, four patterns of conductor shapes are formed with Bx=0 and Sz=0, or Bx>0, or Sz>0 and Nz=0, or Sz>0 and Nz>0. FIG. 3 is a schematic diagram illustrating the four patterns of conductors and the convex portions adjacent to the conductors on the deposition direction side, and omitting other configurations. In reality, the convex portions are arranged at regular intervals according to the pitch of the convex portions, and the conductors are deposited onto them.

FIG. 3 illustrates the four patterns of conductor shapes within the surface of the optical element and the convex portions adjacent to and on the deposition direction side on the conductors, but in reality, a plurality of convex portions and conductors exist between the four patterns of conductors. Since the substrate is a curved surface, the conductor shapes between the four patterns change continuously or stepwise within the surface of the optical element. Dx, Bx, Sz, and Nz also change continuously or stepwise in the first direction of the optical element from one end side to the other end side. That is, the thickness in the first direction of the conductor at each end surface of the plurality of convex portions changes in a direction from one end side to the other end side in the first direction of the transmissive reflective element. As a result, the conductor shape is no longer uniform within the surface of the optical element, and the polarization characteristic (optical characteristic) changes.

This polarization characteristic change results in changes in luminance and color, and occurs in a direction orthogonal to the extending direction of the thin conductor wire. Therefore, of the maximum value of the color difference (ΔE*_{ab}) of the transmission light in the horizontal direction to the extending direction of the thin conductor wire 1 and the maximum value of the color difference of the transmission light in the orthogonal direction, the maximum value of the color difference of the transmission light in the orthogonal direction is greater. In other words, the maximum value of the first color difference of the transmission light in the direction orthogonal to the second direction (extending direction of the plurality of convex portions 3) of the transmissive reflective element 100 (upper or lower side relative to the center) is greater than the maximum value of the second color difference of the transmission light in the second direction (right or left side relative to the center).

Here, a field angle of a human eye will be discussed. A horizontal field angle is 60° inside and 100° outside, and it is approximately 200° in combination of the right and left eyes, and the vertical field angle is 60° above and 70° below. Among them, a stable fixation field, which is an area where effective information demand can be achieved, is 60 to 90° horizontally and 45° to 70° vertically. Thereby, since the human field is wider in the horizontal direction than in the vertical direction, and luminance and color unevenness that occurs in the horizontal direction (left and right direction) is more noticeable than in the vertical direction (up and down direction), luminance and color unevenness in the horizontal direction may be suppressed.

Accordingly, in a case where the transmissive reflective element 100 is used for a display apparatus (observation apparatus), the following inequality (4) may be satisfied:

$$\vert α1 \vert \leq 45 \qquad ( 4 )$$

where α1 (°) is a used angle between the second direction (extending direction) in which each of the plurality of convex portions 3 extends and a direction in which the user's eyes are aligned within a plane orthogonal to the optical axis 6. The used state is a state in which the display apparatus is used (the user visually recognizes a displayed image on a display element, a mounted state in the case of an HMD, or a state in which the user's eyes are aligned with the optical system in the case of the hand-held display or installation type display).

|a1|≤40, 35, 30, 20, 15, 10, or 5 may be satisfied.

The second direction may be approximately parallel to the direction in which the user's eyes are aligned (α1≈0), so that luminance and color unevenness occurs in the vertical direction.

Assume that an observation optical system (optical apparatus) for the display apparatus includes a first optical system and a second optical system disposed in parallel to the first optical system, and each of the first optical system and the second optical system has the transmissive reflective element 100. In this case, the following inequality (5) may be satisfied:

$$\vert α2 \vert \leq 45 \qquad ( 5 )$$

where α2 (°) is an angle between the second direction (extending direction) and the direction in which the first optical system and the second optical system are arranged in parallel.

|α2|≤40, 35, 30, 20, 15, 10, or 5 may be satisfied.

The second direction may be approximately parallel to the direction in which the first optical system and the second optical system are arranged in parallel (α2≈0) so that luminance and color unevenness occurs in the vertical direction.

The display apparatus or observation optical system in which the transmissive reflective element 100 is disposed as described above enables the observer (viewer) to visually recognize a high-quality image.

In a case where the transmissive reflective element 100 is used for an image pickup apparatus, color unevenness is greatest in the diagonal direction of the image sensor. Thus, color unevenness may be suppressed in the diagonal direction and color unevenness may be generated in the short side direction of the image sensor. Accordingly, each example may satisfy the following inequality (6):

$$\vert α3 \vert < 90 - {tan}^{- 1} ( b / a ) \qquad ( 6 )$$

where a is a length in the long side direction of the image sensor, b is a length of the short side direction of the image sensor, and α3 (°) is an angle between the second direction in which each of the plurality of convex portions 3 extends and the long side direction of the image sensor.

|a3|<40, 35, 30, 20, 15, 10, or 5 may be satisfied.

The second direction may be approximately parallel to the long side direction of the image sensor (α3≈0).

In a case where the transmissive reflective element 100 is disposed in this manner, the luminance and color unevenness of the transmissive reflective element 100 occurs in a direction orthogonal to the extending direction of the thin conductor wire, so that the occurrence in the long side direction of the image sensor is suppressed, and an acquired image with less luminance and color unevenness can be obtained.

A color difference ΔE*_{ab} of 1.2 can be easily recognized by most people in determining images side by side. Therefore, in a case where the maximum value of the color difference ΔE*_{ab} is 1.2 or more, the extending direction of the thin conductor wire may be aligned with a direction in which the eyes are aligned or the long side direction of the image sensor so that the luminance and color unevenness occurs in the vertical direction where it is difficult to notice. Thereby, the effect of each example can be improved. Here, the color difference is a color difference in the CIELAB space. The maximum color difference in the horizontal direction may be 0.4 or less with respect to the extending direction of the thin conductor wire 1 of the optical element. In terms of design, the conductor is uniformly formed in the extending direction of the uneven structure, and the color difference in the horizontal direction is 0. However, in reality, color unevenness in the horizontal direction occurs during film formation because the thickness of the conductor varies in the direction in which the uneven structure extends due to installation errors in the deposition machine. Therefore, in a case where the maximum color difference in the horizontal direction is 0.4 or less, a conductor can be obtained in which the thickness variation within the surface of the optical element is suppressed.

In each example, the thickness Ax and the pitch P in the first direction of the conductor 4 in the region above the top surface of the largest convex portion 3 within the surface of the transmissive reflective element 100 may satisfy the following inequality (7):

$$0. 25 \leq Ax / P \leq 0.55 \qquad ( 7 )$$

Satisfying inequality (7) can provide even better polarization separation performance. In a case where the value of Ax/P, which is a ratio of thickness of the conductor to the pitch P illustrated in inequality (7), is close to the lower limit, the transmittance increases, and a transmissive reflective element with high transmittance can be provided. However, as the transmittance increases, the transmittance of unnecessary light increases. Thus, the polarization separation performance reduces, and it becomes difficult to obtain a transmissive reflective element with high contrast. On the other hand, in a case where this value increases, the transmittance decreases, but the transmittance of S-polarized light is suppressed, thus a good polarization separation function is exhibited, and a high-contrast transmissive reflective element can be obtained. Thus, the characteristic of the transmissive reflective element can be controlled by the shape of the conductor according to the purpose of use. In other words, the thickness Ax is a thickness in the first direction of the conductor 4 in the third direction outside of the upper surface (end surface) for each of the plurality of convex portions 3.

Inequality (7) may be replaced with inequality (7a) below:

$$0. 27 \leq Ax / P \leq 0.54 \qquad ( 7 a )$$

Inequality (7) may be replaced with inequality (7b) below:

$$0. 29 \leq Ax / P \leq 0.53 \qquad ( 7 b )$$

Each example will be described in detail below.

### Example 1

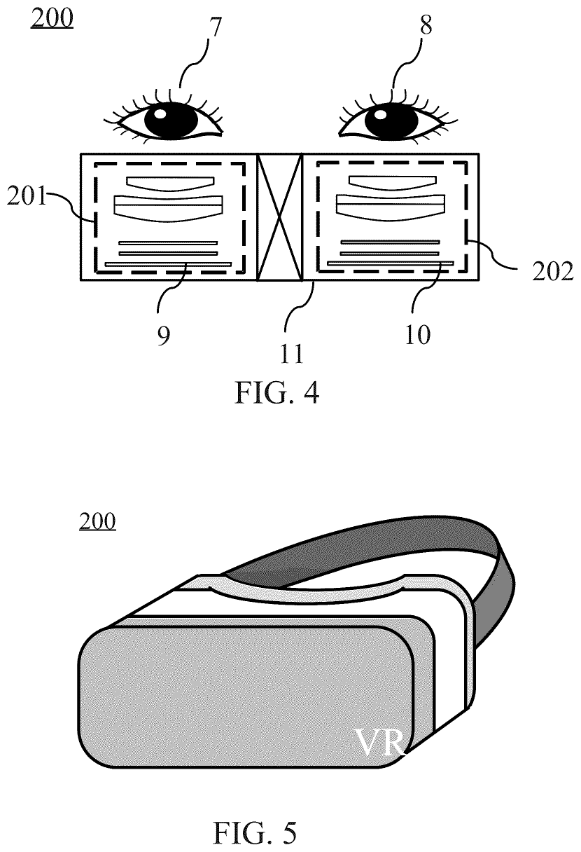

Referring now to FIGS. 4 and 5, a description will be given of a head-mounted display (HMD) (display apparatus, optical apparatus) 200 according to Example 1 of the present disclosure. FIG. 4 is a sectional view of the HMD 200. FIG. 5 is an external view of the HMD 200.

The HMD 200 includes an optical system (first optical system) 201 and an optical system (second optical system) 202 as observation optical systems. Each of the optical systems 201 and 202 includes a lens, a display apparatus, a polarizer, a curved polarization-selective transmissive reflective element, a half-mirror, and a quarter wave-plate, and the lens configurations of the optical systems 201 and 202 are the same. In FIG. 4, reference numeral 7 denotes an observer's right eye, and reference numeral 8 denotes an observer's left eye. The optical systems 201 and 202 are housed in a goggle-type case 11, and are disposed relative to the right eye 7 and the left eye 8, respectively.

The HMD 200 is worn on the head of an observer and used. The observer views images enlarged on the display apparatus (display element) 9 and 10 through the optical systems 201 and 202. On the display apparatuses 9 and 10, separate images with parallax are projected, which allows the observer to view a stereoscopic image.

The curved polarization-selective transmissive reflective element has a curved surface with a maximum opening angle of 18 degrees, and a flat back surface, and the curved surface side of the substrate is a spherical shape and provided with thin conductor wires.

FIG. 6 is a side view of the transmissive reflective element 100 according to this example. The material forming the substrate 2 and the convex portions 3 is a cycloolefin copolymer, the convex portions 3 have a periodic structure with a pitch P of 130 nm, a height h of 170 nm, and a width w of 25 nm in the third direction at the position of the top of the convex portion 3.

The material forming the conductor 4 is aluminum, and the shape of the conductor 4 is obtained by oblique deposition simulation at a deposition angle of 28 degrees only on one side of the convex portion. FIG. 6(a) illustrates the conductor shape at the center, FIG. 6(b) illustrates the conductor shape at one end, and FIG. 6(c) illustrates the conductor shape at the other end. Although the thin conductor wires between each of both ends and the center are omitted, the conductor shape changes continuously or stepwise according to the incident angle of the deposition material to each convex portion.

The conductor shape in FIG. 6(a) has Sz=0 and Bx=0, Dx is 23 nm, and Dz is 41 nm. The conductor shape in FIG. 6(b) has Sz>0 and Nz>0, Dx is 32 nm, Dz is 38 nm, Sz=65 nm, and Nz=29 nm. The conductor shape at the other end has Bx>0, Dx is 23 nm, Dz is 37 nm, Bx=24 nm, and Bz=29 nm. The film thickness, Bx, Sz, and Nz of the conductor shape between each of both ends and the center decrease or increase stepwise or continuously. The average thickness Ax of the conductor in the first direction above the top surface of the convex portion in the optical element plane is 51 nm.

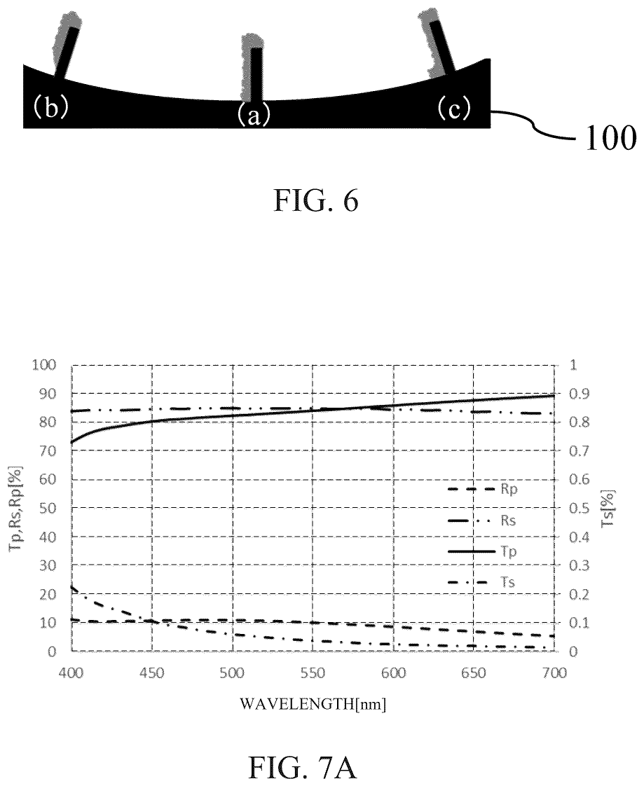

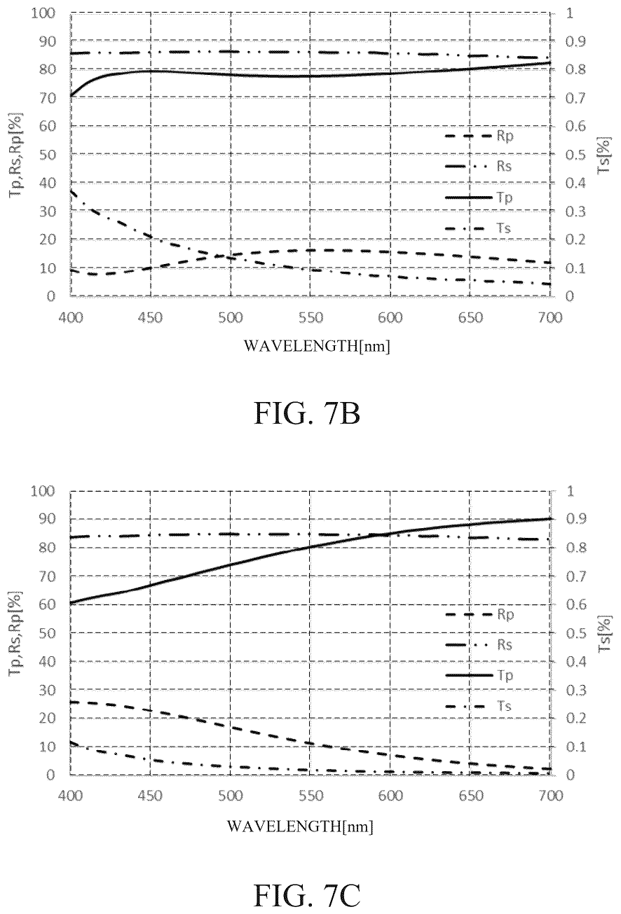

FIGS. 7A, 7B, and 7C illustrate the transmittance and reflectance in this example, and illustrates the results of rigorous coupled-wave analysis (RCWA) of the conductor shape. FIG. 7A illustrates the results for the conductor shape of FIG. 6(a) at one end, FIG. 7B illustrates the results for the conductor shape of FIG. 6(b) at the center, and FIG. 7C illustrates the results for the conductor shape of FIG. 6(b) at the other end. In FIGS. 7A, 7B, and 7C, the horizontal axis illustrates wavelength (nm), and the vertical axis illustrates transmittance (%) or reflectance (%). Tp (%) is the transmittance of P-polarized light, Ts (%) is the transmittance of S-polarized light, Rp (%) is the reflectance of P-polarized light, and Rs (%) is the reflectance of S-polarized light.

A maximum value of the color difference ΔE*_{ab} of the transmission light in the direction orthogonal to the extending direction of the thin conductor wire of the transmissive reflective element is 7.3, and a design value of the color difference ΔE*_{ab} of the transmission light in the horizontal direction is 0. Here, the transmission light is the product of Rs and Tp. In reality, the final observation light is the product of Rs and Tp of the transmissive reflective element and the spectral characteristics of a variety of members in the optical system, but since the transmittance of these members is common, the color difference is calculated from the product of Rs and Tp. In addition, the hue of the display apparatus is based on FIG. 7A, which corresponds to the center of the optical element, in order to apply electrical correction so that it becomes white at the center of the image. Therefore, the color difference is a difference in hue between the center of the optical element and another part of the optical element.

Since the substrate on the thin conductor wire side is spherical, the areas where the shape changes most significantly in comparison with the conductor shape at the center portion are both ends. Therefore, the RCWA results illustrate only the center portion and both ends, and the maximum color difference in each direction is also the value at the ends. The light source for evaluating the transmission light is not limited, as long as the same light source is used in order to compare the color difference.

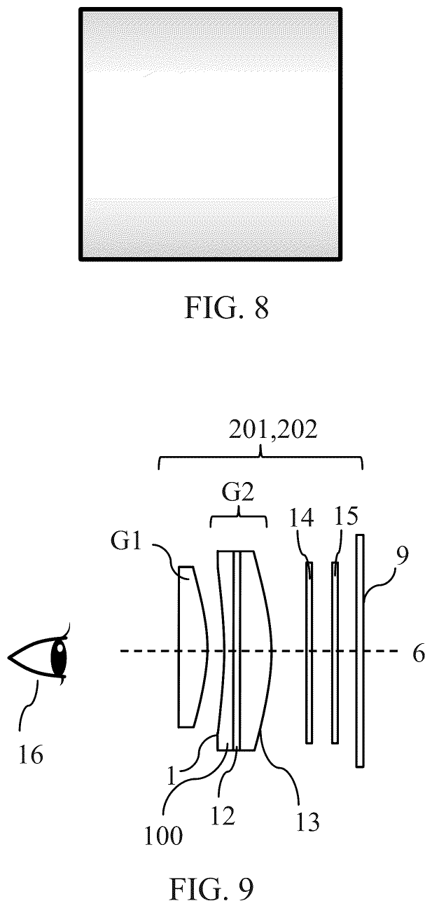

FIG. 8 illustrates color unevenness of the transmission light of the transmissive reflective element 100 according to this example based on the center portion. In FIG. 7B, the P-polarized light transmittance for wavelengths of 550 nm or more is lower than in FIG. 7A, so hue is bluish. On the other hand, in FIG. 7C, the P-polarized light transmittance for wavelengths of 550 nm or less is lower than in FIG. 7A, so the color unevenness is yellowish.

Since the maximum open angle is 18 degrees and the surface is curved, if a conductor is formed by oblique deposition at a fixed angle only on one side of the convex portion, the conductor shape changes greatly within the surface of the transmissive reflective element. Thus, the polarization characteristic changes significantly, and as a result, the color difference of the transmission light also increases.

FIG. 9 is a sectional view of the observation optical system (optical systems 201 and 202). Each of the optical systems 201 and 202 includes a first lens G1, a second lens G2, a second quarter waveplate 14, a polarizer 15, and a display apparatus 9. The second lens G2 is a cemented element including the transmissive reflective element 100, a first quarter waveplate 12, and a half-mirror 13 on its surface. The display apparatus 9 is a display element such as a liquid crystal display element or an organic EL element.

Light emitted from the display apparatus 9 is converted into linearly polarized light by the polarizer 15, and then converted into circularly polarized light by the second quarter waveplate 14 and enters the half-mirror 13. A part of the light that enters the half-mirror 13 is reflected and converted into circularly polarized light in the reverse direction, and returns to the second quarter waveplate 14. The circularly polarized light in the reverse direction that returns to the second quarter waveplate 14 is converted by the second quarter waveplate 14 into linearly polarized light having a polarization direction orthogonal to the polarization direction when it passed through the first polarizer 15, and returns to the polarizer 15, where it is absorbed.

On the other hand, the remaining light incident on the half-mirror 13 transmits through the half-mirror 13, is converted by the first quarter waveplate 12 into linearly polarized light with the same polarization direction as that when it passed through the polarizer 15, and then enters the transmissive reflective element 100. This linearly polarized light is reflected by the polarization selectivity of the transmissive reflective element 100. The light reflected by the transmissive reflective element 100 is converted by the first quarter waveplate 12 into circularly polarized light in a rotation direction opposite to that when it was first converted into circularly polarized light by the second quarter waveplate 14, and then enters the half-mirror 13, where it is reflected.

The light reflected by the half-mirror 13 becomes circularly polarized light with a rotation direction opposite to that of the light before reflection, enters the first quarter waveplate 12, and is converted into linearly polarized light with a polarization direction orthogonal to the polarization direction when it first passed through the polarizer 15, and enters the transmissive reflective element 100. This linearly polarized light passes through the transmissive reflective element 100 due to its polarization selectivity and is guided to an eye 16. An image projected on the display apparatus 9 is magnified and observed by the refractive optical elements having refractive power disposed in each of the optical paths in the optical systems 201 and 202.

The HMD 200 is worn on the head of the observer and used. The optical systems 201 and 202 enable the observer to view the magnified images of the display apparatus 9 and 10. Separate images with parallax are projected onto the display apparatus 9 and 10, and thereby the observer can view a stereoscopic image.

The uneven structure of each of the curved polarization-selective half-transmissive reflective elements of the optical systems 201 and 202 in the HMD 200 extends in the horizontal direction, which is a direction in which the eyes are aligned. Therefore, color unevenness occurs in the vertical direction (up and down direction), which is less noticeable to human vision, and thus the observer can view a high quality image.

In this example, color unevenness in the transmittance has different hues and color differences at both ends. For example, the optical systems may be installed so that blue unevenness, which has a low visibility to humans, may appear on the lower side with a wide vertical field angle of humans, and yellow unevenness, which has a higher visibility than that of blue unevenness, may appear on the upper side with a narrow vertical field angle of humans, in order to make the color unevenness less noticeable. The optical systems may be installed so that the color unevenness with a larger color difference may appear on the upper side with a narrow vertical field angle of humans, so as to minimize the influence of the color unevenness.

### Comparative Example 1

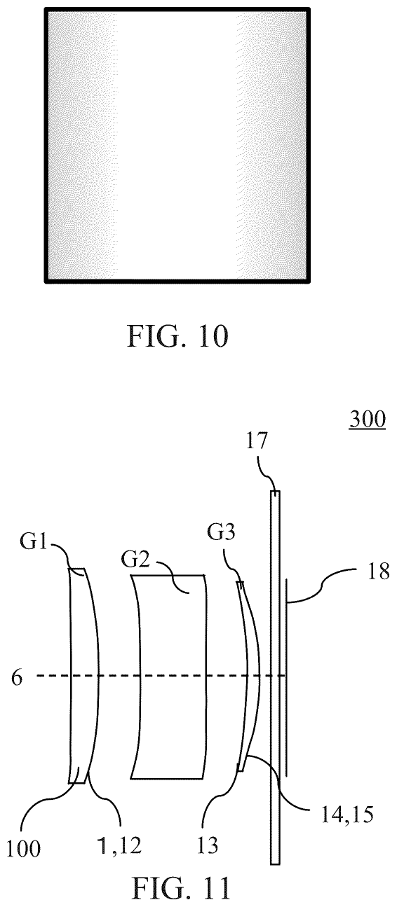

Comparative example 1 is directed to a HMD with the same configuration as that of Example 1, but the uneven structure of the curved polarization-selective half-transmissive reflective element in each of the two optical systems extends in the vertical direction orthogonal to the horizontal direction in which the eyes are aligned. FIG. 10 illustrates color unevenness of transmission light of the curved polarization-selective half-transmissive reflective element according to comparative example 1 based on the center portion. Since the uneven structure of the curved polarization-selective half-transmissive reflective element extends in the vertical direction, color unevenness occurs in the horizontal direction (left and right direction) which is easily noticeable to human vision.

### Example 2

A description will now be given of an image pickup apparatus 300 according to Example 2 of the present disclosure. FIG. 11 is a sectional view of the image pickup apparatus 300 according to this example. The image pickup apparatus 300 includes an imaging optical system and an image sensor 18. The imaging optical system includes, in order from the object side to the image surface side, a first lens G1, a second lens G2, a third lens G3, and a sensor protective glass 17.

The first lens G1 is a transmissive reflective element 100, and has a thin conductor wire 1 and a first quarter waveplate 12 on the image side. The third lens G3 has a half-mirror 13 on the object side, and a second quarter waveplate 14 and a polarizer 15 on the image side.

Light incident on the imaging optical system from the object side becomes linearly polarized light at the transmissive reflective element 100, becomes circularly polarized light at the first quarter waveplate 12, and enters the half-mirror 13. A part of the light that reaches the half-mirror 13 is reflected and becomes circularly polarized light in the reverse direction, and returns to the first quarter waveplate 12.

The circularly polarized light in the reverse direction that returned to the first quarter waveplate 12 returns to the transmissive reflective element 100 by the first quarter waveplate 12 as linearly polarized light polarized in a direction orthogonal to that when it first passed through the transmissive reflective element 100. It is then reflected by the transmissive reflective element 100. Here, due to the polarization selectivity of the transmissive reflective element 100, linearly polarized light polarized in a direction orthogonal to that when it first passed through the transmissive reflective element 100 is reflected.

On the other hand, a part of the light that reaches the half-mirror 13 transmits through it and is converted into linearly polarized light polarized by the second quarter waveplate 14 in the same direction as that when it passed through the transmissive reflective element 100, and enters the polarizer (linear polarizer) 15 and is absorbed by the polarizer 15.

The light reflected by the transmissive reflective element 100 is converted into circularly polarized light by the first quarter waveplate 12 and enters the half-mirror 13. A part of the light that reaches the half-mirror 13 transmits through it and enters the second quarter waveplate 14. This incident light is converted by the second quarter waveplate 14 into linearly polarized light that is parallel to the linearly polarized light reflected by the transmissive reflective element 100. The light that passes through the second quarter waveplate 14 enters the polarizer 15. Here, the polarization of the light and the transmission axis of the polarizer coincide, so most of the light transmits through it and is guided to the imaging surface of the image sensor 18.

Due to the above action, only the light that transmits through the transmissive reflective element 100, is reflected by the half-mirror 13, is reflected by the transmissive reflective element 100, and transmits through the half-mirror 13 is guided to the imaging surface of the image sensor 18.

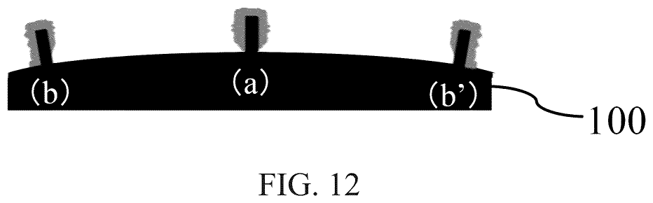

Here, the transmissive reflective element 100 has a curved surface with a maximum opening angle of 6 degrees and a flat back surface, and the curved surface side of the substrate is spherical and has thin conductor wires 1. FIG. 12 is a side view of the transmissive reflective element 100 according to this example. FIG. 12 is a deformed side view, unlike the actual scale.

The material forming the substrate 2 and the convex portions 3 is a cycloolefin copolymer, the convex portions 3 have a periodic structure with a pitch P of 80 nm, a height h of 60 nm, and a width w of 15 nm in the third direction at the top of the convex portion. The material forming the conductor 4 is aluminum, and the conductor 4 is applied to both side surfaces of the convex portion. This conductor shape is formed by depositing the conductor on the top surface and one side surface of the convex portion and at least a part of the concave portion by oblique deposition simulation at a deposition angle θ of 50.3 degrees, which is an angle between the optical axis and the deposition direction. The optical element is then rotated by 180 degrees and the conductor is deposited on the other side surface of the convex portion by oblique deposition simulation from a similar angle, and a conductor shape is obtained by depositing the conductor on both sides of the convex portion illustrated in FIG. 12. (b) and (b′) in FIG. 12 are conductor shapes that are approximately symmetrical to each other.

The conductor (a) at the center portion has a conductor shape that is approximately symmetrical when divided into left and right with respect to the centerline that passes through the center of the width of the convex portion, e.g., Sz>0 and Nz>0. The conductors on the right and left sides when divided into left and right with respect to the centerline that passes through the center of the width of the convex portion have Dx of 13.5 nm, Nz of 6.1 nm, Sz of 17.2 nm, and Dz of 22.4 nm.

The left side of the conductor (b) at one end when divided into left and right with respect to the centerline that passes through the center of the width of the convex portion, or the right side of the conductor (b′) at the other end when divided into left and right with respect to the centerline that passes through the center of the width of the convex provide a conductor shape with Bx=0 and Sz=0, and Dx is 12.9 nm. Furthermore, the right side of the conductor (b) at the one end when divided into left and right with respect to the centerline that passes through the center of the width of the convex portion or the left side of the conductor (b′) at the other end when divided into left and right with respect to the centerline that passes through the center of the width of the convex provide a conductor shape with Sz>0 and Nz>0. The conductor shape has Sz of 22 nm, Nz of 11.6 nm, and Dx of 14 nm. Dz at the end is 22.5 nm.

The conductor shape between the center portion and the end is such that the film thickness increases or decreases stepwise or continuously. The average thickness Ax in the first direction of the conductor above the top surface of the convex portion within the surface of the transmissive reflective element is 42.0 nm.

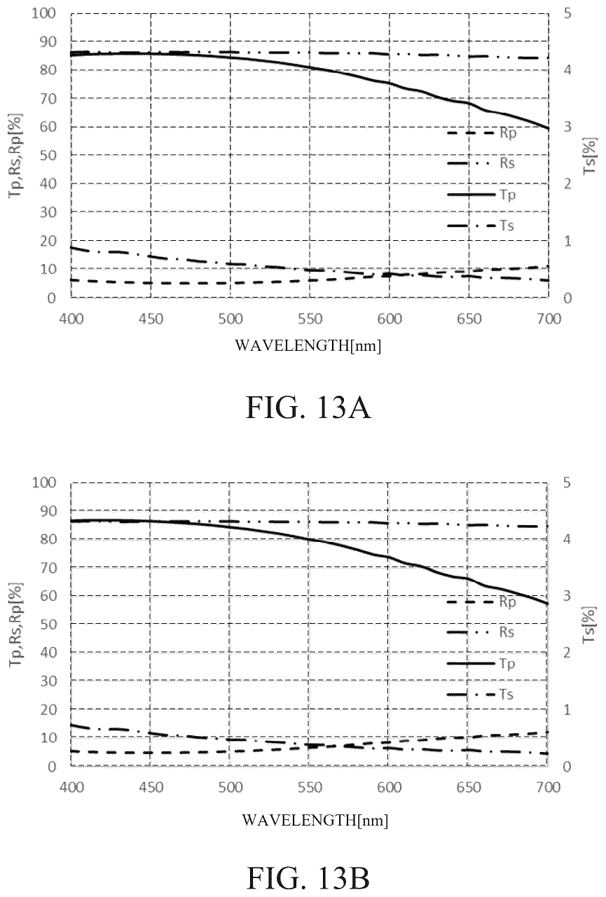

The RCWA results using the above structure obtained by the oblique deposition simulation at the center portion and at the end portion are illustrated in FIGS. 13A and 13B, respectively. Since the conductor shapes (b) and (b′) at both ends are symmetrical to each other, only (b) is illustrated.

The maximum value of the color difference ΔE*_{ab} of the transmission light in the direction orthogonal to the extending direction of the thin conductor wire of the transmissive reflective element 100 is 1.3, and the design value of the color difference ΔE*_{ab} of the transmission light in the horizontal direction is 0. Since the substrate on the thin conductor wire side is spherical, the area where the shape changes most significantly in comparison with the conductor shape at the center portion are the both ends. Therefore, the RCWA results illustrate only the center portion and both ends, and the maximum value of the color difference in each direction is also the value at the end. Since the conductor shapes on the left and right sides of the transmissive reflective element 100 according to this example is symmetrical with respect to the element centerline, the color unevenness is the same at both ends.

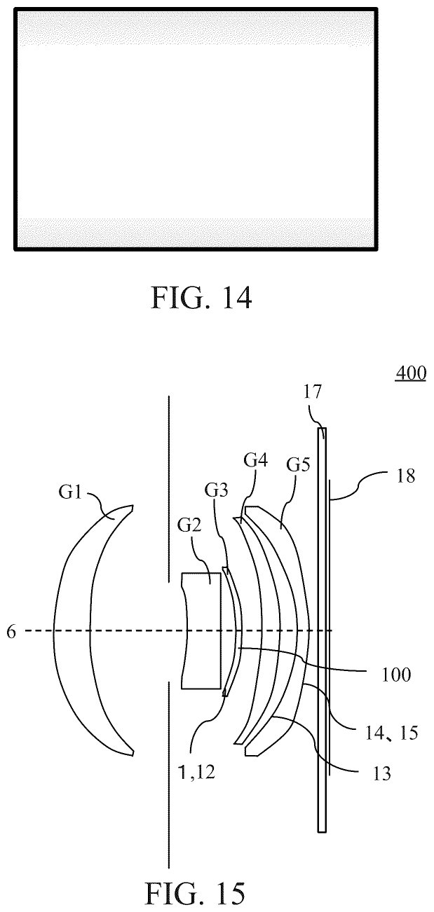

FIG. 14 illustrates color unevenness of transmission light of the transmissive reflective element 100 according to this example based on the center portion. Here, the extending direction of the uneven structure of the transmissive reflective element 100 in the optical system in the image pickup apparatus 300 may be the long side direction of the image sensor 18. Due to this arrangement, the luminance and color unevenness of the transmissive reflective element 100 occurs in a direction orthogonal to the extending direction of the unevenness structure, i.e., in the short side direction of the image sensor 18, and a good image with little luminance and color unevenness can be acquired.

### Example 3

A description will now be given of an image pickup apparatus 400 according to Example 3 of the present disclosure. FIG. 15 is a sectional view of the image pickup apparatus 400 according to this example. The image pickup apparatus 400 includes an imaging optical system and an image sensor 18. The imaging optical system includes, in order from the object side to the image surface side, a first lens G1, a second lens G2, a third lens G3, a fourth lens G4, a fifth lens G5, and a sensor protective glass 17.

The third lens G3 is a transmissive reflective element 100, and includes a thin conductor 4 and a first quarter waveplate 12 on the image side. The fifth lens G5 includes a half-mirror 13 on the object side, and a second quarter waveplate 14 and a polarizer 15 on the image side.

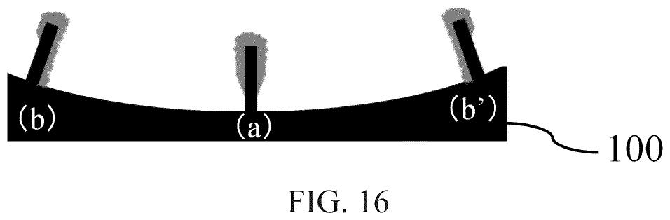

The surface of the transmissive reflective element 100 that includes the thin conductor 4 has a spherical shape with a maximum opening angle of −20 degrees. FIG. 16 is a side view of the transmissive reflective element 100 according to the present example. FIG. 16 is a deformed side view, different from the actual scale.

The material forming the substrate 2 and the convex portions 3 is a cycloolefin copolymer, and the convex portions 3 has a periodic structure with a pitch P of 150 nm, a height h of 250 nm, and a width w of 35 nm in the third direction at the position of the top of the convex portion. The material forming the conductor 4 is aluminum, and the conductor is deposited onto both side surfaces of the convex portion. This conductor shape is obtained by depositing the conductor onto the top surface and one side of the convex portion and at least a part of the concave portion by oblique deposition simulation at a deposition angle θ of 32 degrees, which is an angle between the optical axis and the deposition direction. Thereafter, the optical element is rotated by 180 degrees and the conductor is deposited onto the other side of the convex portion by oblique deposition simulation at a similar angle. Thereby, the conductor shape with the conductor applied to both sides of the convex portion can be obtained as illustrated in FIG. 16. (b) and (b′) in FIG. 16 are approximately symmetrical conductor shapes.

The conductor (a) at the center portion has a conductor shape that is approximately symmetrical when divided into left and right with respect to the centerline that passes through the center of the width of the convex portion, e.g., Sz>0 and Nz>0. The conductors on the left and right sides when divided into left and right with respect to the centerline that passes through the center of the width of the convex portion have Dx of 5.3 nm, Nz of 66 nm, Sz of 74.5 nm, and Dz of 16.9 nm.

The left side of the conductor (b) at one end when divided into left and right with respect to the centerline that passes through the center of the width of the convex portion, or the right side of the conductor (b′) at the other extreme end when divided into left and right with respect to the centerline that passes through the center of the width of the convex provide a conductor shape with Sz>0 and Nz>0. Sz is 129.7 nm, Nz is 122.3 nm, and Dx is 6.7 nm. In addition, the right side of the conductor (b) at the one end when divided into left and right with respect to the centerline that passes through the center of the width of the convex portion or the left side of the conductor (b′) at the other end when divided into left and right with respect to the centerline that passes through the center of the width of the convex portion provides a conductor shape with Bx=0 and Sz=0, and Dx is 3.7 nm. Dz at the end is 16.7 nm. The conductor shape between the center portion and the end increases or decreases in thickness stepwise or continuously. The average thickness Ax in the first direction of the conductor above the top surface of the convex portion within the surface of the transmissive reflective element is 45.5 nm.

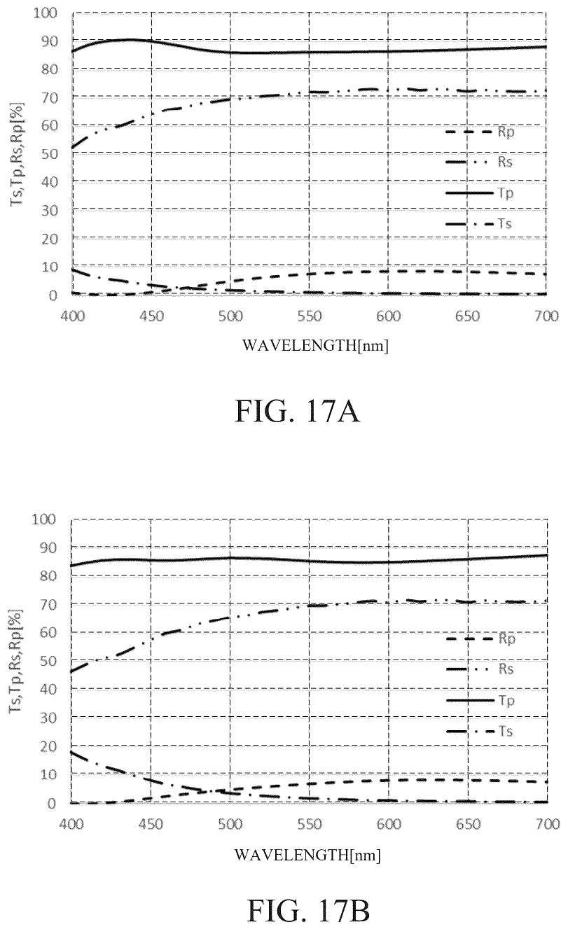

The RCWA results using the above structure obtained by the oblique deposition simulation at the center portion and at the end portion are illustrated in FIG. 17A and FIG. 17B, respectively. Since the conductor shapes (b) and (b′) at both ends are symmetrical to each other, only (b) is illustrated.

The maximum value of the color difference ΔE*_{ab} of the transmission light in the direction orthogonal to the extending direction of the thin conductor wire of the transmissive reflective element 100 is 5.0, and the design value of the color difference ΔE*_{ab} of the transmission light in the horizontal direction is 0. Since the substrate on the thin conductor wire side is spherical, the area where the shape changes most significantly in comparison with the conductor shape at the center portion is the both ends. Therefore, the RCWA results illustrate only the center portion and both ends, and the maximum value of the color difference in each direction is also the value at the end. Since the conductor shapes on the left and right sides of the transmissive reflective element 100 according to this example is symmetrical with respect to the element centerline, the color unevenness is the same at both ends.

Here, the extending direction of the uneven structure of the transmissive reflective element 100 in the optical system in the image pickup apparatus 400 may be the long side direction of the image sensor 18. Due to such an arrangement, the luminance and color unevenness of the transmissive reflective element 100 occurs in a direction orthogonal to the extending direction of the uneven structure, i.e., in the short side direction of the image sensor 18, and a good image with little luminance and color unevenness can be acquired.

Table 1 illustrates numerical values regarding the inequalities of Examples 1 to 3 and comparative example 1.

TABLE 1

| | | | | Comparative |
|---|---|---|---|---|
| | Example 1 | Example 2 | Example 3 | Example 1 |
| h | 170 nm | 60 nm | 250 nm | 170 nm |
| p | 130 nm | 80 nm | 150 nm | 130 nm |
| Maximum | 7.3 | 1.3 | 5.0 | 7.3 |
| ΔE*_{ab} in | | | | |
| Orthogonal | | | | |
| Direction | | | | |
| Maximum | 0.0 | 0.0 | 0.0 | 0.0 |
| ΔE*_{ab} in | | | | |
| Horizontal | | | | |
| Direction | | | | |
| Direction of | Vertical (Up- | Short Side | Short Side | Horizontal |
| Luminance | Down) | Direction | Direction | (Left-Right) |
| and Color | Direction | | | Direction |
| Unevenness | | | | |

In a case where the film-shaped wire grid polarizers disclosed in Japanese Patent Application Laid-Open Nos. 2021-81530 and 2010-39183 are applied to a curved optical element, an image may contain color unevenness, and thus a high-quality image may not be obtained. On the other hand, each example can provide a display apparatus, an optical apparatus, and an image pickup apparatus, each of which can provide high-quality images.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-102328, which was filed on Jun. 25, 2024, and which is hereby incorporated by reference herein in its entirety.

What is claimed is:

1. A display apparatus comprising:
an optical system including a transmissive reflective element; and
a display element,
wherein the transmissive reflective element includes:
a substrate having a curved surface,
a plurality of convex portions disposed on the curved surface along a first direction, and
a conductor provided on each of the plurality of convex portions,
wherein each of the plurality of convex portions extends in a second direction orthogonal to the first direction and protrudes in a third direction orthogonal to each of the first direction and the second direction,
wherein each of the plurality of convex portions has an end surface in the third direction and a first side surface and a second side surface disposed on both sides of the end surface in the first direction,
wherein in a section including the first direction and the third direction, the conductor covers at least a part of the end surface and at least a part of the first side surface of each of the plurality of convex portions, and
wherein the following inequality is satisfied:
$$\vert α1 \vert \leq 45$$
where α1 (°) is an angle in a used state between the second direction and a direction in which user's eyes are aligned.

2. The display apparatus according to claim 1, wherein the second direction is parallel to a direction in which the user's eyes are aligned.

3. The display apparatus according to claim 1, wherein a thickness of the conductor in the first direction at the end surface of each of the plurality of convex portions changes in a direction from one end side to another end side of the transmissive reflective element in the first direction.

4. The display apparatus according to claim 1, wherein the substrate and the plurality of convex portions are integrated with each other.

5. The display apparatus according to claim 1, wherein a maximum value of a first color difference of transmission light in a direction orthogonal to the second direction of the transmissive reflective element is greater than a maximum value of a second color difference of the transmission light in the second direction.

6. The display apparatus according to claim 5, wherein the maximum value of the first color difference is 1.2 or more, and the maximum value of the second color difference is 0.4 or less.

7. The display apparatus according to claim 1, wherein the following inequality is satisfied:
$$50 \leq h \leq 300$$
where h (nm) is a height of each convex portion in the third direction in the section.

8. The display apparatus according to claim 1, wherein the following inequality is satisfied:
$$70 \leq P \leq 170$$
where P (nm) is an arrangement pitch of the plurality of convex portions in the section.

9. The display apparatus according to claim 1, wherein the following inequality is satisfied:
$$0. 25 \leq Ax / P \leq 0.55$$
where P (nm) is an arrangement pitch of the plurality of convex portions, and Ax (nm) is a thickness of the conductor in the first direction outside of the end surface in the third direction for each of the plurality of convex portions.

10. An optical apparatus comprising:
a first optical system and a second optical system arranged in parallel,
wherein each of the first optical system and the second optical system includes a transmissive reflective element,
wherein the transmissive reflective element includes:
a substrate having a curved surface,
a plurality of convex portions disposed on the curved surface along a first direction, and
a conductor provided on each of the plurality of convex portions,
wherein each of the plurality of convex portions extends in a second direction orthogonal to the first direction and protrudes in a third direction orthogonal to each of the first direction and the second direction,
wherein each of the plurality of convex portions has an end surface in the third direction and a first side surface and a second side surface disposed on both sides of the end surface in the first direction,
wherein in a section including the first direction and the third direction, the conductor covers at least a part of the end surface and at least a part of the first side surface of each of the plurality of convex portions, and
wherein the following inequality is satisfied:
$$\vert α2 \vert \leq 45$$
where α2 (°) is an angle between the second direction and an arrangement direction of the first optical system and the second optical system.

11. The optical apparatus according to claim 10, wherein the second direction is parallel to the arrangement direction.

12. An image pickup apparatus comprising:
an optical system including a transmissive reflective element; and
an image sensor,
wherein the transmissive reflective element includes:
a substrate having a curved surface,
a plurality of convex portions disposed on the curved surface along a first direction, and
a conductor provided on each of the plurality of convex portions,
wherein each of the plurality of convex portions extends in a second direction orthogonal to the first direction and protrudes in a third direction orthogonal to each of the first direction and the second direction,
wherein each of the plurality of convex portions has an end surface in the third direction and a first side surface and a second side surface disposed on both sides of the end surface in the first direction,
wherein in a section including the first direction and the third direction, the conductor covers at least a part of the end surface and at least a part of the first side surface of each of the plurality of convex portions, and
wherein the following inequality is satisfied:
$$\vert α3 \vert < 90 - {tan}^{- 1} ( b / a )$$
where a is a length in a long side direction of the image sensor, b is a length in a short side direction of the image sensor, and α3 (°) is an angle between the second direction and the long side direction.

13. The image pickup apparatus according to claim 12, wherein the second direction is parallel to the long side direction.

14. The image pickup apparatus according to claim 12, wherein a thickness of the conductor in the first direction at the end surface of each of the plurality of convex portions changes in a direction from one end side to another end side of the transmissive reflective element in the first direction.

15. The image pickup apparatus according to claim 12, wherein the substrate and the plurality of convex portions are integrated with each other.

16. The image pickup apparatus according to claim 12, wherein a maximum value of a first color difference of transmission light in a direction orthogonal to the second direction of the transmissive reflective element is greater than a maximum value of a second color difference of the transmission light in the second direction.

17. The image pickup apparatus according to claim 16, wherein the maximum value of the first color difference is 1.2 or more, and the maximum value of the second color difference is 0.4 or less.

18. The image pickup apparatus according to claim 12, wherein the following inequality is satisfied:
$$50 \leq h \leq 300$$
where h (nm) is a height of each convex portion in the third direction in the section.

19. The image pickup apparatus according to claim 12, wherein the following inequality is satisfied:
$$70 \leq P \leq 170$$
where P (nm) is an arrangement pitch of the plurality of convex portions in the section.

20. The image pickup apparatus according to claim 12, wherein the following inequality is satisfied:
$$25 \leq Ax / P \leq 0.55$$
where P (nm) is an arrangement pitch of the plurality of convex portions, and Ax (nm) is a thickness of the conductor in the first direction outside of the end surface in the third direction for each of the plurality of convex portions.
